(19) United States
(12) Patent Application Publication
(10) Pub. No.: US 2024/0161611 A1
(43) Pub. Date: May 16, 2024

(54) Traffic Signal Control Assembly

(71) Applicant: Janet D. Scott, San Antonio, TX (US)

(72) Inventor: Janet D. Scott, San Antonio, TX (US)

(21) Appl. No.: 17/984,740

(22) Filed: Nov. 10, 2022

(51) Int. Cl. G08G 1/087; G08G 1/017; G08G 1/095

(52) U.S. Cl. CPC G08G 1/087; G08G 1/017; G08G 1/095

(57) ABSTRACT

A traffic signal control assembly for facilitating passage of an emergency vehicle through an intersection includes a plurality of identification modules, which interface with a plurality of detection and verification modules. Each identification module is mountable to a respective emergency vehicle of a plurality of emergency vehicles. Each detection and verification module is mountable to a respective traffic signal of a plurality of traffic signals, which is installed at an intersection and interfaced with a controller. The detection and verification module is communicatively engaged to the controller. The detection and verification module detects approach of the respective emergency vehicle to the respective traffic signal, authenticates the respective emergency vehicle, and signals the controller, which turns the respective traffic signal green and the remainder of the plurality of traffic signals red, thereby allowing passage of the respective emergency vehicle through the intersection.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to control assemblies and more particularly pertains to a new control assembly for facilitating passage of an emergency vehicle through an intersection. The present invention discloses a control assembly . . . .

### (2) Description of Related Art Including Information Disclosed Under 37 CFR 1.97 and 1.98

The prior art relates to control assemblies, which may comprise devices to preempt control of traffic signals, display units mountable to traffic signals, and the like. Related prior art comprises visual and audio warning devices for intersections that are not interfaced with traffic signals. What is lacking in the prior art is a control assembly comprising identification modules attached to emergency vehicles, which are only actuated concurrently with their sirens, and detection and verification modules, which are attached to traffic signals and their controllers. The traffic signals are altered to allow safe passage of the emergency vehicles, but only when their sirens are sounding and the emergency vehicles have been authenticated.

### BRIEF SUMMARY OF THE INVENTION

An embodiment of the disclosure meets the needs presented above by generally comprising a plurality of identification modules, which interface with a plurality of detection and verification modules. Each identification module is configured to be mounted to a respective emergency vehicle of a plurality of emergency vehicles. Each detection and verification module is configured to be mounted to a respective traffic signal of a plurality of traffic signals, which is installed at an intersection and interfaced with a controller. The detection and verification module is communicatively engaged to the controller. The detection and verification module is configured to detect approach of the respective emergency vehicle to the respective traffic signal, to authenticate the respective emergency vehicle, and to signal the controller. The controller is enabled to turn the respective traffic signal green and the remainder of the plurality of traffic signals red, thereby allowing passage of the respective emergency vehicle through the intersection.

Another embodiment of the disclose includes a traffic signal control system, which comprises a plurality of emergency vehicles, each fitted with an identification module, and a plurality of traffic signals, each fitted with a detection and verification module.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an in-use view of a traffic signal control assembly according to an embodiment of the disclosure.

FIG. 2 is an in-use view of an embodiment of the disclosure.

FIG. 3 is a block diagram of an embodiment of the disclosure.

### DETAILED DESCRIPTION OF THE INVENTION

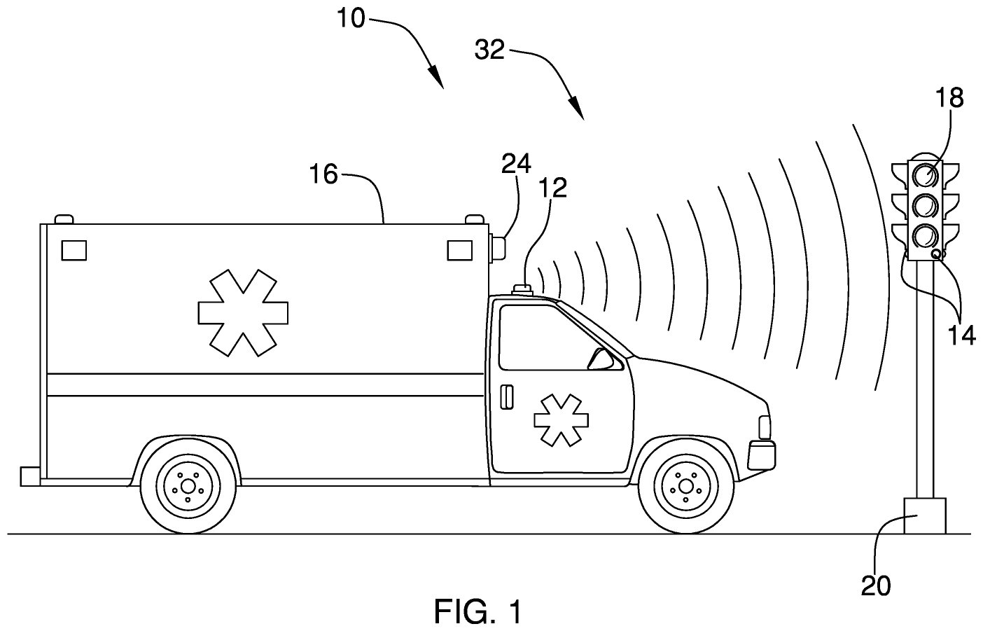

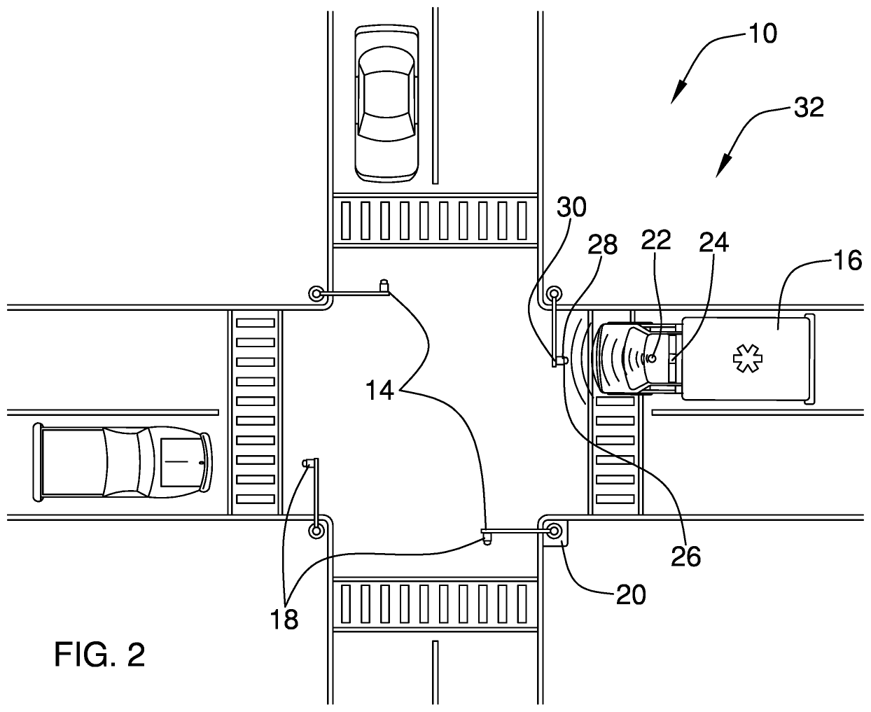

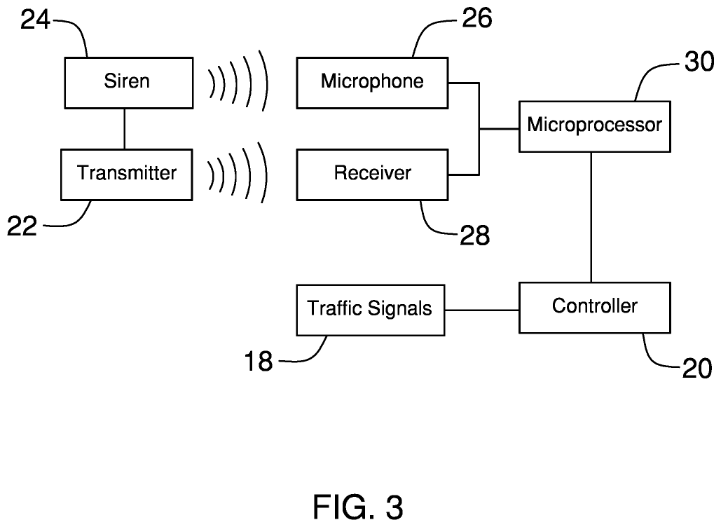

With reference now to the drawings, and in particular to FIGS. 1 through 3 thereof, a new control assembly embodying the principles and concepts of an embodiment of the disclosure and generally designated by the reference numeral 10 will be described.

As best illustrated in FIGS. 1 through 3, the traffic signal control assembly 10 generally comprises a plurality of identification modules 12, which interface with a plurality of detection and verification modules 14. Each identification module 12 is configured to be mounted to a respective emergency vehicle 16 of a plurality of emergency vehicles 16. Each detection and verification module 14 is configured to be mounted to a respective traffic signal 18 of a plurality of traffic signals 18, which is installed at an intersection and interfaced with a controller 20. The detection and verification module 14 is communicatively engaged to the controller 20 and is configured to detect approach of the respective emergency vehicle 16 to the respective traffic signal 18, to authenticate the respective emergency vehicle 16, and to signal the controller 20. The controller 20 is enabled to turn the respective traffic signal 18 green and the remainder of the plurality of traffic signals 18 red, thereby allowing passage of the respective emergency vehicle 16 through the intersection. Once the respective emergency vehicle 16 has passed through the intersection, the controller 20 returns the plurality of traffic signals 18 to normal operation.

The present invention is anticipated to be beneficial in speeding up emergency response times, reducing accidents involving emergency vehicles 16, and in reducing stress of operators of emergency vehicles 16.

The identification module 12 comprises a transmitter 22, which is configured to emit a unique authentication signal concurrently with an alert being broadcast by a siren 24 of the respective emergency vehicle 16. As the transmitter 22 is only actuated concurrently with the siren 24, the plurality of traffic signals 18 will not be manipulated unless the emergency vehicle 16 is on a call.

The detection and verification module 14 comprises a microphone 26, a receiver 28, and a microprocessor 30. The microphone 26 is configured to detect the alert when the respective emergency vehicle 16 is approaching the respective traffic signal 18. The receiver 28 is configured to receive the unique authentication signal. The microprocessor is operationally engaged to the microphone 26 and the receiver 28 and thus is enabled to actuate the receiver 28 upon the microphone 26 detecting an alert. The microprocessor authenticates the unique authentication signal and then signals the controller 20 to turn the respective traffic signal 18 green and to turn the remainder of the plurality of traffic signals 18 red.

The present invention anticipates programming code positioned on the microprocessor 30 enabling the microprocessor 30 to perform Doppler analysis on the alert, thereby enhancing the ability of the detection and verification module 14 to detect both approach and departure of the respective emergency vehicle 16. The present invention also anticipates other types of identification modules 12 and detection and verification modules 14. For example, the identification module 12 may comprise a visual authentication code and the detection and verification module 14 may comprise a camera.

The present invention also anticipates a traffic signal control system 32, which comprises a plurality of emergency vehicles 16, each fitted with an identification module 12, and a plurality of traffic signals 18, each fitted with a detection and verification module 14. The traffic signal control system 32 also comprises a controller 20, which is interfaced with the plurality of traffic signals 18. A detection and verification module 14 detects approach of a respective emergency vehicle 16 to an associated traffic signal 18, authenticates the respective emergency vehicle 16, and signals the controller 20 so that the controller 20 turns the associated traffic signal 18 green and the remainder of the plurality of traffic signals 18 red, thereby allowing passage of the respective emergency vehicle 16 through the intersection.

In use, the identification modules 12 are mounted to the emergency vehicles 16 and the detection and verification modules 14 are mounted to the traffic signals 18 and interfaced with the controller 20. When a detection and verification module 14 detects approach of an emergency vehicle 16 to an associated traffic signal 18, it authenticates the emergency vehicle 16 and signals the controller 20. The controller 20 turns the associated traffic signal 18 green and the remainder of the plurality of traffic signals 18 red, thereby allowing passage of the emergency vehicle 16 through the intersection.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A traffic signal control assembly comprising:
a plurality of identification modules, each identification module being configured for mounting to a respective emergency vehicle of a plurality of emergency vehicles; and
a plurality of detection and verification modules, each detection and verification module being configured for mounting to a respective traffic signal of a plurality of traffic signals installed at an intersection and interfaced with a controller, such that the detection and verification module is communicatively engaged to the controller, wherein the detection and verification module is configured for detecting approach of the respective emergency vehicle to the respective traffic signal, for authenticating the respective emergency vehicle, and for signaling the controller, such that the controller is enabled for turning the respective traffic signal green and the remainder of the plurality of traffic signals red, thereby allowing passage of the respective emergency vehicle through the intersection.

2. The traffic signal control assembly of claim 1, wherein:
the identification module comprises a transmitter configured for emitting a unique authentication signal; and
the detection and verification module comprises:
a microphone, wherein the microphone is configured for detecting an alert broadcast by a siren of the respective emergency when the respective emergency vehicle is approaching the respective traffic signal,
a receiver configured for receiving the unique authentication signal, and
a microprocessor operationally engaged to the microphone and the receiver, such that the microprocessor is enabled for actuating the receiver upon the microphone detecting an alert, for authenticating the unique authentication signal, and for signaling the controller for turning the respective traffic signal green and the remainder of the plurality of traffic signals red.

3. A traffic signal control assembly comprising:
a plurality of identification modules, each identification module being configured for mounting to a respective emergency vehicle of a plurality of emergency vehicles, the identification module comprising a transmitter configured for emitting a unique authentication signal; and
a plurality of detection and verification modules, each detection and verification module being configured for mounting to a respective traffic signal of a plurality of traffic signals installed at an intersection and interfaced with a controller, such that the detection and verification module is communicatively engaged to the controller, wherein the detection and verification module is configured for detecting approach of the respective emergency vehicle to the respective traffic signal, for authenticating the respective emergency vehicle, and for signaling the controller, such that the controller is enabled for turning the respective traffic signal green and the remainder of the plurality of traffic signals red, thereby allowing passage of the respective emergency vehicle through the intersection, the detection and verification module comprising:
a microphone, wherein the microphone is configured for detecting an alert broadcast by a siren of the respective emergency when the respective emergency vehicle is approaching the respective traffic signal,
a receiver configured for receiving the unique authentication signal, and
a microprocessor operationally engaged to the microphone and the receiver, such that the microprocessor is enabled for actuating the receiver upon the microphone detecting an alert, for authenticating the unique authentication signal, and for signaling the controller for turning the respective traffic signal green and the remainder of the plurality of traffic signals red.

4. A traffic signal control system comprising:
a plurality of emergency vehicles;
a plurality of identification modules, each identification module being mounted to a respective emergency vehicle; and
a plurality of traffic signals installed at an intersection and interfaced with a controller;
a plurality of detection and verification modules, each detection and verification module being mounted to a respective traffic signal, such that the detection and verification module is communicatively engaged to the controller, such that the detection and verification module detects approach of the respective emergency vehicle to the respective traffic signal, authenticates the respective emergency vehicle, and signals the controller, such that the controller turns the respective traffic signal green and the remainder of the plurality of traffic signals red, thereby allowing passage of the respective emergency vehicle through the intersection.

5. The traffic signal control system of claim 4, wherein:
the identification module comprises a transmitter configured for emitting a unique authentication signal; and
the detection and verification module comprises:
a microphone, wherein the microphone is configured for detecting an alert broadcast by a siren of the respective emergency when the respective emergency vehicle is approaching the respective traffic signal,
a receiver configured for receiving the unique authentication signal, and
a microprocessor operationally engaged to the microphone and the receiver, such that the microprocessor is enabled for actuating the receiver upon the microphone detecting an alert, for authenticating the unique authentication signal, and for signaling the controller for turning the respective traffic signal green and the remainder of the plurality of traffic signals red.
